(19) United States
(12) Patent Application Publication
(10) Pub. No.: US 2014/0227918 A1
(43) Pub. Date: Aug. 14, 2014

(54) SOLDERABLE CONTACT

(71) Applicant: Amphenol-Tuchel Electronics GmbH, Heilbronn (DE)

(72) Inventors: Marc Norridge, Untergruppenbach (DE); Alan Raclawski, Mainhardt (DE)

(73) Assignee: August-HauBer-StraBe 10, Heilbronn (DE)

(21) Appl. No.: 14/344,552

(22) PCT Filed: Aug. 4, 2012
(86) PCT No.: PCT/EP2012/003345

§ 371 Date: Mar. 12, 2014

(30) Foreign Application Priority Data
Aug. 30, 2011 (DE) 10 2011 112 014.2

(51) Int. Cl. H01R 13/17

(52) U.S. Cl. CPC H01R 13/17
USPC 439/884

(57) ABSTRACT

The invention relates to a solderable contact formed by a substantially U-shaped contact part consisting of a base plate with two legs that are joined to the base plate. A spring arm which is arranged on one leg extends in the direction of the leg opposite said leg. The opposite leg has two lateral wings which are form-fittingly connected to the leg by means of connecting sections.

The invention relates to a solder contact according to the preamble of claim 1.

The invention thus relates to a resilient solder contact for soldering onto a component carrier, in particular onto a printed circuit board.

Different solder-contact embodiments are known from the prior art.

DE 602 20 266 T2 discloses a spring contact which is formed from an elastic metal plate, is made up of a base strip and of a contact strip and in which the contact strip is spaced apart transversally from the base strip, and a gap is formed therebetween, and also an elastic bending region is provided, this region connecting one end of the base strip to the end of the contact strip, wherein the base strip and the contact strip run in the longitudinal direction and the elastic bending region is subjected to elastic prestressing.

Solder contacts are generally soldered onto a printed circuit board or onto a contact pad or a contact location of a printed circuit board.

These contacts are subjected to different levels of mechanical and thermal loading during transportation and processing.

It is therefore problematic, in practical usage, to provide sufficiently robust and stable solder contacts which are suitable, in particular, for transportation purposes and use with handling equipment, are of sufficiently stable design and also in the soldered state, in loading and non-loading positions, can be fastened securely, and in a deformation-free manner, on the printed circuit board.

It is therefore an object of the present invention to provide, for a printed circuit board, a stable solder contact, in particular a resilient solder contact, which is of sufficiently dimensionally stable configuration and withstands mechanical and thermal loads occurring.

In other words, the intention is to avoid the technical problem of a contact spring being subjected to permanent deformation and indicated deformation or deformation which occurs during assembly.

The contact according to the invention will also be referred to hereinbelow as a clip, since it is essentially a resilient contact.

Extremely small numbers of the clips according to the invention are defective, or become damaged, during assembly and transportation.

It is therefore possible to reduce costs and minimize the reject rates.

During assembly, the contacts are forcibly held at a location by a gripper, which may result in deformation and builds up internal stressing within the contact, which can introduce forces into the contact as a result of unintended deformation.

At a later stage, during soldering, the contacts then tilt and move out of their intended position.

This gives rise to incorrect heights, reduced normal forces or other material-related problems, which adversely affect the electrical performance and service life of the contacts or result in the contact system failing altogether.

The contact according to the invention is in the form of a U, a wing structure being formed at one U-shaped end, or wings being arranged on both sides, of the same. These wings perform a force-dissipating function.

In more general terms, the invention provides a resilient solder contact which has a basic shape which is essentially in the form of a U and on which two inwardly projecting wings are formed at least on one leg of the U shape.

These protective U-shaped wings also constitute a kind of “shield for protecting the contact springs”.

The contact according to the invention also has a soldering channel on the underside, extending into one side leg of the solder contact.

The soldering channel on the one hand gives rise to a stable connection for the base of the solder contact, and this has a positive influence on shearing and pull-off forces.

On the other hand, lateral twisting, in particular rotation, is avoided, and therefore, once again, the risk of damage is reduced, by a combination of the wings with the air channel.

A further aspect in favor of the inwardly inclined wings is the fact that the situation where the contact becomes caught, in particular with, for example, work gloves, is avoided.

In a particularly advantageous embodiment, the U wings are appropriately provided with a radius along their edges and the corners have no sharp angles.

The invention will be explained in more detail hereinbelow by way of preferred embodiments and with reference to the accompanying drawings, in which:

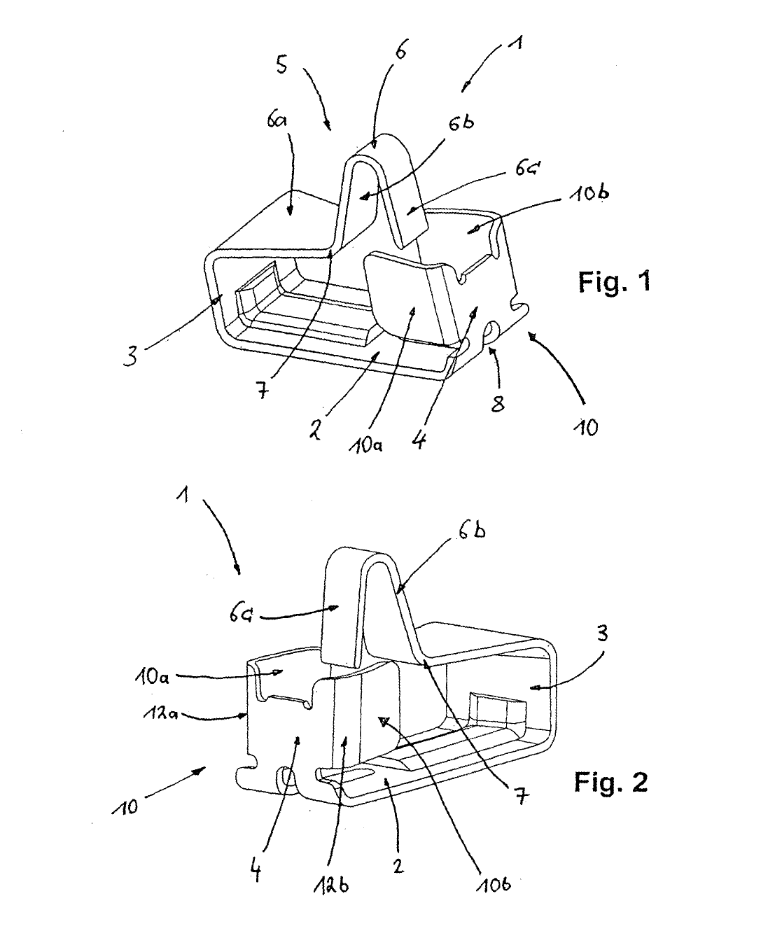

FIG. 1 shows a perspective view of a first exemplary embodiment of the invention;

FIG. 2 shows the exemplary embodiment from FIG. 1 in a view which is similar to FIG. 1, but is turned to show it from a different perspective;

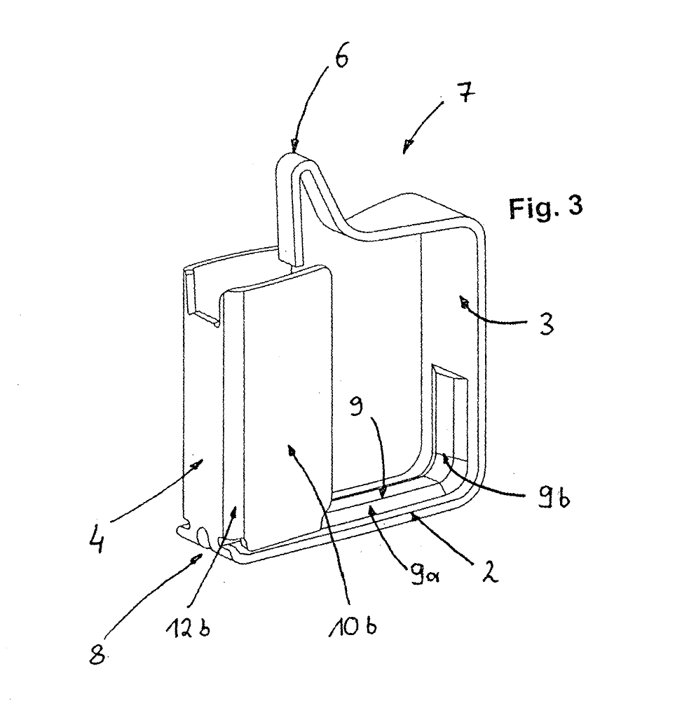

FIG. 3 shows an alternative exemplary embodiment similar to the embodiments from FIGS. 1 and 2;

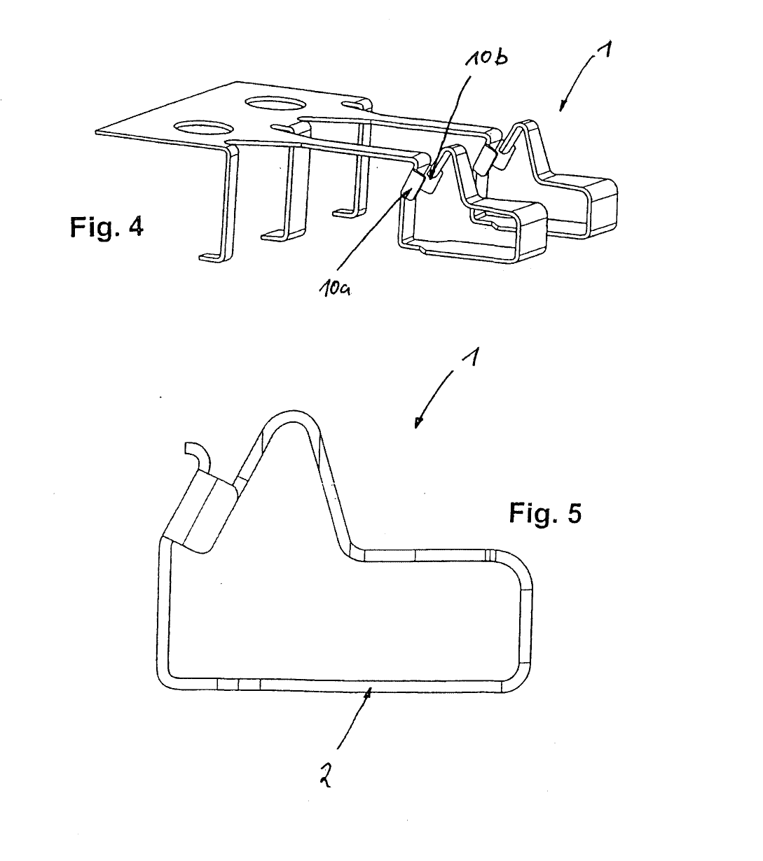

FIG. 4 shows a basic interim-production stage of a solder contact according to the invention, attached to a pilot strip; and

FIG. 5 shows a side view of a detail according to FIG. 4.

FIGS. 1 and 2 illustrate a first exemplary embodiment of the invention, to be precise a solder contact 1 or a clip 1.

The solder contact 1 is designed as an essentially U-shaped solder contact 1 made up of a base plate 2 with two legs 3, 4.

The U shape is intended to denote the formation of the base plate 2 and of the two legs 3, 4, these being oriented in relation to one another, and fastened on one another, essentially at a 90° angle.

The base plate, as shown in FIG. 1, is designed as an essentially elongate or rectangular base plate 2, a leg plate 3 and leg plate 4 being arranged at each of its longitudinal ends.

The leg plate 3, 4 will be referred to hereinbelow as legs 3, 4 for short.

The leg 3 has fastened on it a spring arm 5, which has a first spring-arm portion 6a, which runs essentially parallel to the base plate and is adjoined, via a bend 7, by a second spring-arm portion 6b, which is bent away from the base plate and is adjoined, via a spring hump 6, by a third spring-arm portion 6c which, as a result of the curvature on the spring hump 6, is bent back in the direction counter to the second spring-arm portion 6b, to be precise roughly in the direction of the base plate 2.

This gives rise to an essentially V-shaped design of the spring arm 5, formed from the spring-arm portions 6b, 6c.

In a particularly advantageous embodiment, the spring hump 6 is curved to follow a radius.

As can be seen in FIG. 2, the leg 4, which is located opposite the leg 3, has two wings 10a, 10b, which form a reinforcing portion 10 together with the leg 4.

The wings 10a, 10b are connected to the leg 4 in a form-fitting manner via connecting portions 12a, 12b, to be precise bent connecting portions 12a, 12b.

In addition, the wings 10a, 10b are curved and, by way of a radius of curvature, run slightly inward, that is in the direction of the respectively opposite wing.

This gives rise to an essentially U-shaped reinforcing portion 10 in which the two legs of the U are formed by the wings 10a, 10b, although the U has to be in a kind of curved form.

This provides a particularly stable and deformation-resistant clip 1.

FIG. 3 shows an exemplary embodiment which is an alternative to FIGS. 1 and 2 and in which the legs 3, 4 are of lengthened design, and thus the spring hump 6 is clearly spaced apart from the base plate 2.

This makes it possible to produce scalable clips which, formed likewise with the wings 10a, 10b, as can be seen in FIG. 3, are particularly stable clips despite their height.

A further feature of the clip 1 according to the invention is illustrated in FIGS. 1, 2 and 3, to be precise a soldering channel 9 is formed in the region of the base plate 2. The soldering channel 9 as a first soldering-channel portion 9a runs in the region of the base plate 2 and opens out into the leg 3. A soldering-channel portion 9b is thus located in the leg 3. The two soldering-channel portions 9a, 9b thus run beyond the connecting locations between the base plate 2 and the leg 3, and this provides for a particularly stable, torsionally rigid shape.

Furthermore, the soldering channel is suitable for achieving particularly stable solder connections which, in respect of the cutout 8, which is offset in relation to the soldering channel, is likewise arranged in the base plate, to be precise longitudinally along the base plate 2. The cutout 8 preferably runs into the leg 4.

As a result, solder can flow into the cutout 8 during soldering, and forms an abutment in relation to the channel formed by the soldering channel 9.

According to the invention, this provides a particularly stable clip 1 which is capable of robust connection.

FIGS. 4 and 5 show schematically, by way of example, preliminary stages in the production of the clip according to the invention, formed on a pilot strip. An example of a clip 1 in which the wings 10a, 10b are indicated purely schematically is shown on the pilot strip according to FIG. 4.

According to the invention, however, the wings 10a, 10b should be designed such that they fill approximately 20% to 30% of the cross-sectional surface area of the U-shaped clip 1, formed when viewed in side view, in order to create sufficient (dimensional) stability.

### LIST OF DESIGNATIONS

### Solder Contact

1 Clip (solder contact, resilient solder contact)
2 Base plate
3 Leg
4 Leg
5 Spring arm
6 Spring hump
6a Spring-arm portion
6b Spring-arm portion
6c Spring-arm portion
7 Bend
8 Cutout
9 Soldering channel
9a First soldering-channel portion
9b Second soldering-channel portion
10 Reinforcing portion
10a Wing
10b Wing
11 Recess
12a, 12b Connecting portion

1. A solder contact formed from an essentially U-shaped contact part, wherein the U-shaped contact part comprises a base plate with two legs formed on the base plate, and wherein the one leg has arranged on it a spring arm which extends in the direction of the leg, which is located opposite the leg, characterized in that the leg has two laterally formed wings, which are connected to the leg in a form-fitting manner via connecting portions.

2. The solder contact as claimed in claim 1, characterized in that the wings are designed as bent wings.

3. The solder contact as claimed in claim 1, characterized in that the bending of the wings is configured such that the latter are curved toward one another.

4. The solder contact as claimed in claim 1, characterized in that a soldering channel is formed in the base plate.

5. The solder contact as claimed in claim 1, characterized in that a soldering-channel portion is formed, as a continuation of the soldering channel or as a part thereof, in at least the leg.

6. The solder contact as claimed in claim 1, characterized in that a cutout is provided in the base plate.

7. The solder contact as claimed in claim 1, characterized in that the surface area of the wings is at least 20% to 30% of the cross-sectional surface area of the U-shaped contact part.
